(19) United States
(12) Patent Application Publication
(10) Pub. No.: US 2023/0321741 A1
(43) Pub. Date: Oct. 12, 2023

(54) HEAT-STAKING DEVICES AND METHODS

(71) Applicant: Pipeline Design & Engineering, LLC, Tempe, AZ (US)

(72) Inventors: Aaron Robison, Phoenix, AZ (US); Benjamin Mark Sandoval, Tempe, AZ (US); John Bradley Martell, Chandler, AZ (US); Craig Ovans, Chandler, AZ (US); Pedro Rafael Tula del Moral Testai, Mesa, AZ (US)

(21) Appl. No.: 18/297,480

(22) Filed: Apr. 7, 2023

Related U.S. Application Data
(60) Provisional application No. 63/329,345, filed on Apr. 8, 2022.

(51) Int. Cl. B23K 3/02; B23K 3/03

(52) U.S. Cl. CPC B23K 3/027; B23K 3/0369; B23K 3/0346

(57) ABSTRACT

The disclosure includes a heat-staking device comprising a base, an upright arm coupled to the base, and a head vertically movable along the upright arm. In some embodiments, the head includes a main head unit, a quill coupled to the main head unit, an insulating tip holder coupled to the quill and configured to removably retain a thermal-installation tip, and a handle configured to cause vertical motion of the insulating tip holder. The quill may also include a soldering iron configured to heat the thermal-installation tip. In some embodiments, the heat-staking device is configured to swap out thermal-installation tips while the thermal-installation tips are still hot.

### CROSS-REFERENCE TO RELATED APPLICATIONS

The present application claims priority to U.S. Provisional Patent Application No. 63/329,345 filed on Apr. 8, 2022, entitled “HEAT-STAKING” the entire disclosure of which is incorporated by reference herein.

### BACKGROUND

The present invention relates to devices and methods related to manufacturing and assembly, specifically involving heat-staking.

### SUMMARY

The disclosure includes a heat-staking device comprising a base defining a surface configured to support a working component, an upright arm coupled to the base, and a head vertically movable along the upright arm. In some embodiments, the head comprises a main head unit, a quill coupled to the main head unit, an insulating tip holder coupled to the quill and configured to removably retain a thermal-installation tip, and a handle configured to rotatably move relative to the main head unit to cause a vertical motion of the insulating tip holder relative to the main head unit. The quill may include a soldering iron configured to heat the thermal-installation tip.

In some embodiments, the upright arm includes a plurality of sides, wherein each side of the plurality of sides includes a channel configured to receive a portion of the head to facilitate movement of the head along the upright arm. The head may further comprise a clamp configured to secure the head relative to the upright arm. In some embodiments, the clamp is configured to couple to the channel in at least one side of the plurality of sides of the upright arm.

The heat-staking device may further comprise a quill stop coupled to the main head unit adjacent the handle. In some embodiments, the quill stop is configured to restrict a vertical motion of the insulating tip holder relative to the main head unit. The quill stop may comprise an educated nut configured to move helically along a threaded rod of the main head unit. In some embodiments, the quill stop comprises a bottom quill stop. The heat-staking device may also include a top quill stop.

In some embodiments, the insulating tip holder includes a helical slot configured to receive a radial pin of the thermal-installation tip to thereby couple the thermal-installation tip to the insulating tip holder. The upright arm may comprise a stopper defining a minimum vertical position of the head. In some embodiments, the base comprises a plurality of legs.

The disclosure includes a system comprising a heat-staking device, a heat-resistant case, and a tool. In some embodiments, the heat-staking device includes a base, an upright arm coupled to the base, and a head vertically movable along the upright arm. The head may comprise a main head unit, a quill coupled to the main head unit, an insulating tip holder coupled to the quill and configured to removably retain a thermal-installation tip, and a handle configured to rotatably move relative to the main head unit to cause a vertical motion of the insulating tip holder relative to the main head unit. In some embodiments, the heat-resistant case defines a plurality of receiving areas configured to receive and retain the thermal-installation tip while the thermal-installation tip is not retained within the insulating tip holder. The tool may be configured to detachably couple the thermal-installation tip to the insulating tip holder. In some embodiments, the heat-resistant case comprises a complaint material.

The thermal-installation tip may comprise a first thermal-installation tip. In some embodiments, the system further comprises a plurality of thermal-installation tips, wherein each thermal-installation tip of the plurality of thermal-installation tips is sized and configured to fit a different-sized threaded insert. The plurality of receiving areas of the heat-resistant case may be configured to receive and retain the plurality of thermal-installation tips.

In some embodiments, the thermal-installation tip includes a radial pin. The tool may include a tool helical slot configured to receive the radial pin of the thermal-installation tip to thereby couple the thermal-installation tip to the tool. In some embodiments, the insulating tip holder includes a tip holder helical slot configured to receive the radial pin of the thermal-installation tip to thereby couple the thermal-installation tip to the insulating tip holder.

The disclosure includes a method of heat staking, comprising detachably coupling a thermal-installation tip to a tool, wherein the thermal-installation tip includes a radial pin, and the tool includes a helical slot configured to receive the radial pin; inserting, via the tool, the thermal-installation tip into the insulating tip holder of a heat-staking device; heating, via the quill, the thermal-installation tip; and lowering, via the handle, the thermal-installation tip into a threaded insert to heat and install the threaded insert. In some embodiments, the heat-staking device comprises a base, an upright arm coupled to the base, and a head vertically movable along the upright arm. The head may comprise a main head unit, a quill coupled to the main head unit, the insulating tip holder coupled to the quill and configured to removably retain the thermal-installation tip, and a handle configured to rotatably move relative to the main head unit to cause a vertical motion of the insulating tip holder relative to the main head unit.

In some embodiments, detachably coupling the thermal-installation tip to the tool comprises placing an open end of the tool over a first end of the thermal-installation tip; aligning the radial pin of the thermal-installation tip with the helical slot of the tool; and rotating the tool one-quarter turn in a first direction to engage the radial pin with the helical slot of the tool. Inserting the thermal-installation tip into the insulating tip holder may comprise inserting a second end of the thermal-installation tip into an open end of the insulating tip holder, wherein the second end is located opposite the first end; aligning the radial pin of the thermal-installation tip with a helical slot of the insulating tip holder; rotating the tool one-quarter turn in a second direction to engage the radial pin with the helical slot of the insulating tip holder and disengage the radial pin from the helical slot of the tool, wherein the second direction is opposite the first direction; and removing the tool.

In some embodiments, the method further comprises lifting, via the handle, the thermal-installation tip from the installed threaded insert; removing, via the tool, the thermal-installation tip from the insulating tip holder; and inserting, via the tool, the thermal-installation tip into a case. The tool and the case may be heat-resistant.

The foregoing, and other features and advantages of the invention, will be apparent from the following, more particular description of the preferred embodiments of the invention, the accompanying drawings, and the claims.

### BRIEF DESCRIPTION OF THE DRAWINGS

These and other features, aspects, and advantages are described below with reference to the drawings, which are intended to illustrate, but not to limit, the invention. In the drawings, like characters denote corresponding features consistently throughout similar embodiments.

FIG. 1 illustrates a perspective view of the heat-staking device, according to some embodiments.

FIG. 2 illustrates a side view of the heat-staking device, according to some embodiments.

FIG. 3 illustrates a side cross-sectional view of the head of the heat-staking device, according to some embodiments.

FIG. 4 illustrates a perspective view of the heat-staking device with the head in the “down” position and the handle in the “up” position, according to some embodiments.

FIG. 5 illustrates a perspective view of the heat-staking device with the head in the “up” position and the handle in the “down” position, according to some embodiments.

FIG. 6 illustrates a perspective view of the heat-staking device with an inset detailed view of the head, according to some embodiments.

FIGS. 7A and 7B illustrate an insulating tip holder and a thermal-installation tip in uncoupled and coupled positions, respectively, according to some embodiments.

FIG. 8 illustrates a perspective view of a tool, according to some embodiments.

FIGS. 9 and 10 illustrate perspective views of insulating tip holders, according to some embodiments.

FIG. 11 illustrates a perspective view of a case for thermal-installation tips, according to some embodiments.

FIG. 12 illustrates a method of using a heat-staking device, according to some embodiments.

### COMPONENT INDEX

100—heat-staking device
102—base
104—upright arm
106—head
108—threaded insert tray
200—handle
202—plurality of legs
204—stopper
206—perpendicular support
208—at least one linkage bar
300—main head unit
302—quill
304—insulating tip holder
306—thermal-installation tip
308—soldering iron
310—quill clamp
312—linear bearing
314—heater cartridge
400—plurality of sides
402—clamp
404—channel
406—surface
600a—top quill stop
600b—bottom quill stop
602—threaded rod
700—tip holder helical slot
702—pin
704—label
800—tool
802—tool helical slot
900—insulating tip holder
902—collar
904—thermal-installation tip
1000—insulating tip holder
1002—flexible segments
1100—case
1102—plurality of tubes
1104—size label

### DETAILED DESCRIPTION

“Heat-staking” is a manufacturing process by which two or more working components are assembled at an elevated (“working”) temperature, and then allowed to cool and solidify. For instance, some manufactured components, such as polymer (e.g., thermoplastic) components, produced via processes such as rapid prototyping and injection-molding, can include metallic, heat-set threaded inserts (also referred to herein as “threaded inserts”) to enhance thread strength. These threaded inserts, and associated methods of their installation within working components, are common in industrial manufacturing. Typical threaded-insert installation involves heating and pressing the threaded insert into a cavity defined by the working component. Currently available threaded-insert-installation equipment ranges from standard, hand-held soldering irons (e.g., with unmodified tips), to industrial-grade machines with custom heating elements, to some fully automated equipment capable of installing multiple threaded inserts simultaneously.

This disclosure describes example systems, devices, and techniques for installing and securing threaded inserts within working components, such as polymer (e.g., thermoplastic) components. In some examples described herein, a heat-staking device, such as a threaded-insert installer, includes a temperature controller, a base, an upright, and an adjustable-height head containing a quill to vertically move a heater assembly and at least one thermal-installation tip. Some such examples further include a handle and a linkage configured to amplify the user's input force applied to the threaded insert.

The examples described herein provide novel benefits over typical, currently available threaded-insert-installation machines. For instance, the examples described herein enable a user to rapidly exchange thermal-installation tips (e.g., different-sized installation tips for different-sized threaded inserts) even while the installation tips are still hot, and without requiring additional tools. For instance, in some examples, a threaded-insert installer includes a rapid-exchange mechanism in which the tip holder defines a helical slot configured to receive the affixed pin that extends from the thermal installation tip. These example rapid-exchange mechanisms also provide for a lowered thermal mass, thereby enabling faster heating up to the desired working temperature.

Some examples described herein further provide a common access location enabling a user to quickly and easily adjust multiple parameters (e.g., top and bottom stroke limits of the vertical quill). Additionally, or alternatively, some examples include a heat-resistant case enabling a user to readily identify, exchange, organize, and store a plurality of thermal-installation tips while the tips are still hot.

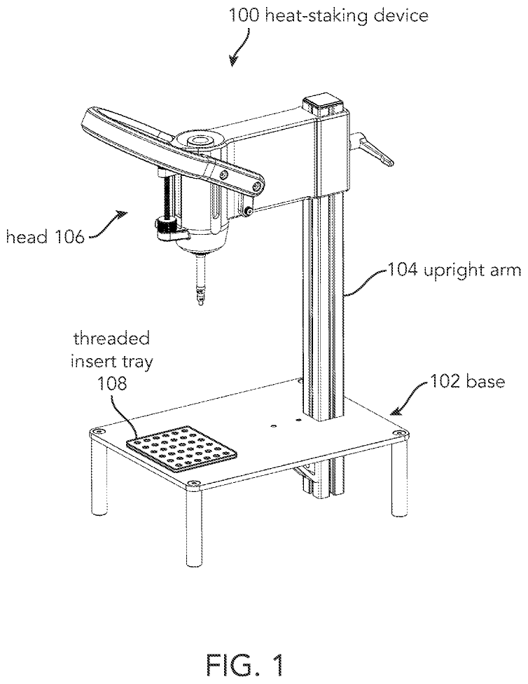

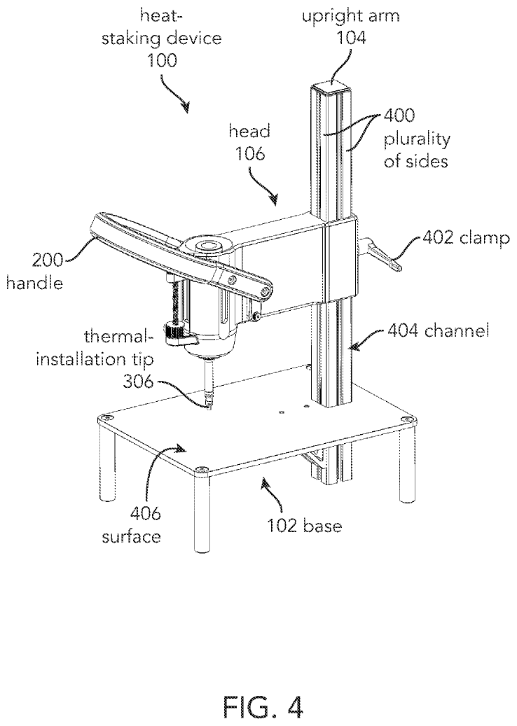

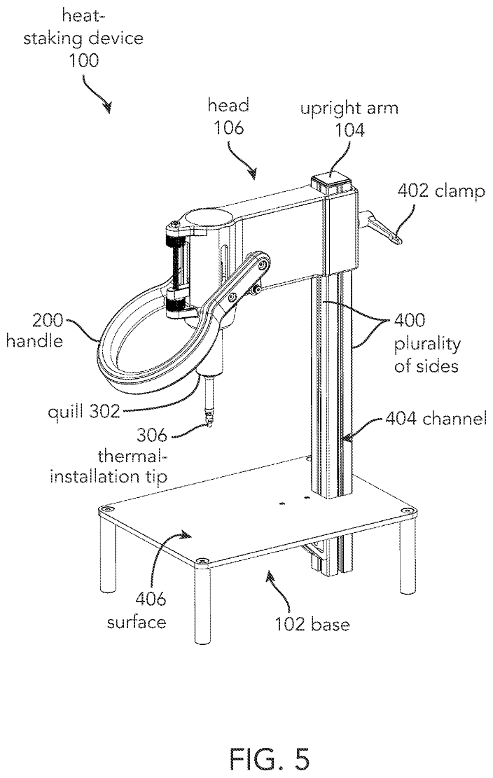

FIG. 1 is a perspective view of a heat-staking device 100, or threaded-insert installer, with a support base 102, an upright arm 104, and a head 106. In the example shown in FIG. 1, the head 106 is in an “up” position relative to the upright arm 104. As will be shown in FIGS. 4 and 5, the head 106 may be configured to move up and down along the upright arm 104. In some embodiments, the base 102 provides a surface on which a working component, such as the threaded insert tray 108, is laid prior to installation of one or more threaded inserts. The movement of the head 106 along the upright arm 104 may facilitate proper positioning of the head 106 relative to the threaded insert tray 108, or other working components, located on the base 102.

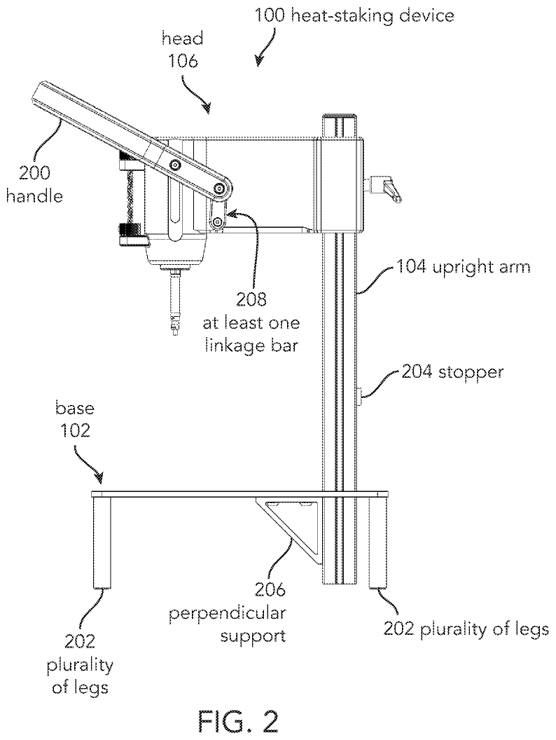

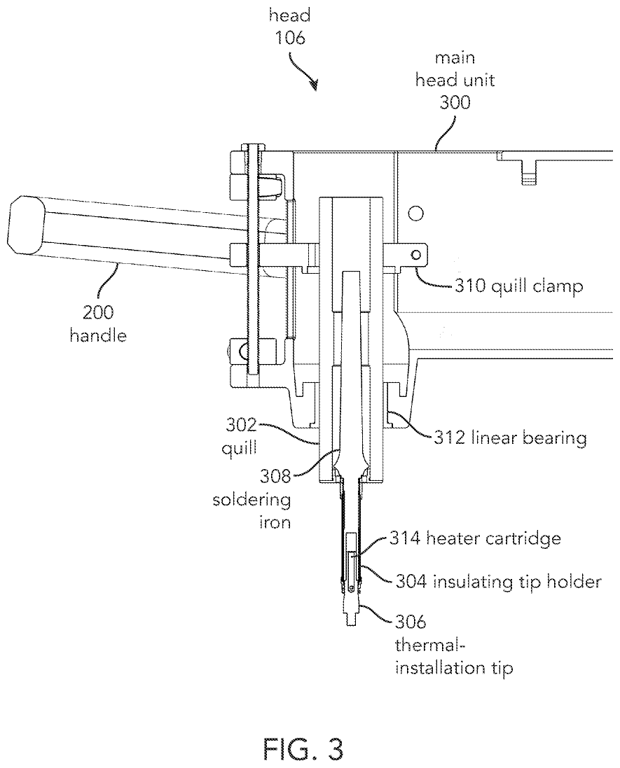

FIG. 2 illustrates a side view of the heat-staking device 100. As shown in FIG. 2, the base 102 may include a plurality of legs 202 configured to elevate the heat-staking device 100 and to provide a storage space under the device 100. In some embodiments, the storage space can house, for example, a temperature controller, additional thermal installation tips, a third-party control device, and/or other accessories. The base may also include a perpendicular support 206 configured to secure the upright arm 104 to the base 102. In some embodiments, the upright arm 104 includes a stopper 204 configured to prevent the head 106 from moving too low on the upright arm 104. Stated another way, the stopper 204 sets a minimum vertical position of the head 106 to prevent unintended contact between the base 102 and a portion of the head 106, such as the thermal-installation tip (shown in FIG. 3).

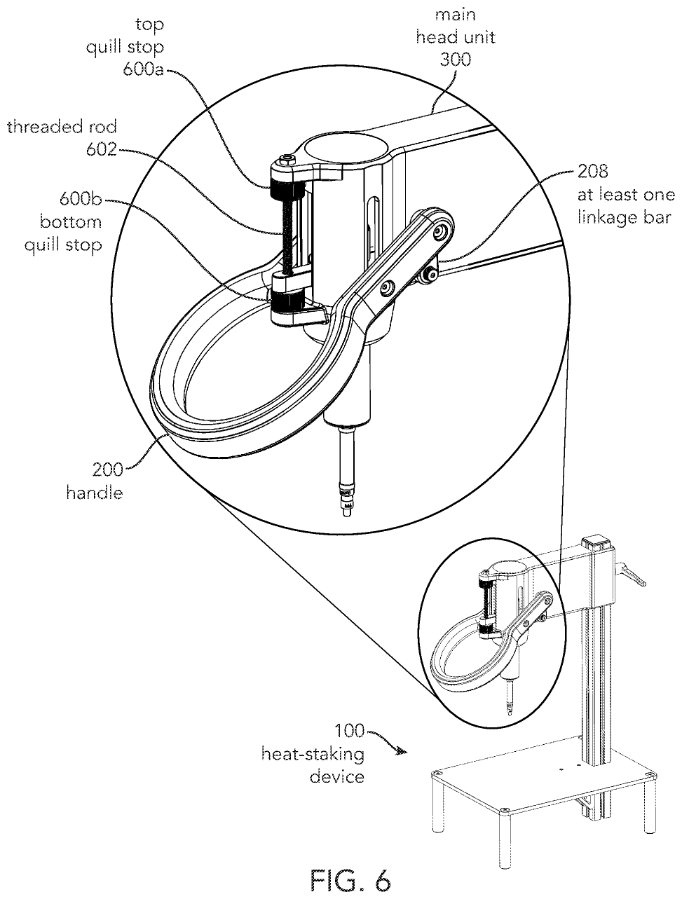

FIG. 2 also shows the handle 200 of the heat-staking device 100. In some embodiments, the handle 200 is configured to rotatably move relative to the head 106 to cause a vertical motion of a portion of the head 106, such as the insulating tip holder (shown in FIG. 3). FIGS. 1 and 2 show the handle 200 in the “up” position relative to the head 106, which keeps various components of the head 106 also in the “up” position. Lowering the handle 200, as shown in FIGS. 5 and 6, causes various components of the head 106 to lower into a “down” position. In some embodiments, at least one linkage bar 208 is coupled to the handle 200 to facilitate movement of the handle 200 and various components of the head 106.

FIG. 3 illustrates a cross-section of the head 106, which may comprise a main head unit 300, a quill 302, an insulating tip holder 304, a soldering iron 308, a quill clamp 310, and a linear bearing 312. In some embodiments, the insulating tip holder 304 is configured to removably retain a thermal-installation tip 306, as shown in FIG. 3. The thermal-installation tip 306 may be heated to a working temperate via conductive heat transfer from the soldering iron 308 located within the quill 302. In some embodiments, the soldering iron 308 includes a heater cartridge 314 that extends into the thermal-installation tip 306 to thereby heat the thermal-installation tip 306 to a temperature sufficient to heat and install a threaded insert.

FIG. 3 also includes the handle 200. In some embodiments, the handle 200 directs an applied force through rotational pivots of the quill clamp 310 which clamps to, and moves along with, the quill 302. The at least one linkage bar 208 shown in FIG. 2 may also include rotational pivots. In some embodiments, the at least one linkage bar 208 is mounted to both sides of the head 106 and the handle 200, and enables the quill 302 to move in a vertical motion during rotational motion of the handle 200 relative to the main head unit 300. The heat-staking device 100 may also include a compression spring (not shown) positioned between the head 106 and a lower surface of the quill clamp 310. The compression spring may provide a substantially constant upward force on the quill 302. In some embodiments, the head 106 includes a linear bearing 312 configured to prevent unintended lateral and radial motion of the quill 302.

As mentioned previously, the handle 200 may be configured to move various components of the head 106, including, by way of the quill clamp 310, the quill 302. The handle 200 may also impart a mechanical advantage and cause vertical motion of other elements coupled (directly or indirectly) to the quill 302, such as the soldering iron 308 and the insulating tip holder 304, which may both be disposed within the quill 302, as well as the thermal-installation tip 306. Accordingly, when the handle 200 is in the “up” position as shown in FIGS. 1, 2, and 4, the quill 302 (and associated components) may also be considered in the “up” position. When the handle 200 is in the “down” position as shown in FIGS. 5 and 6, the quill 302 (and associated components) may also be considered in the “down” position. FIG. 3 shows the handle 200 and, therefore, the quill 302, in a “middle” position between the “up” and “down” positions. The “down” position may be used to lower the thermal-installation tip 306 into a threaded insert, such as a threaded insert placed in the threaded insert tray 108 shown in FIG. 1. Of course, whether or not the thermal-installation tip 306 can reach the threaded insert depends upon the vertical position of the head 106 along the upright arm 104.

FIGS. 4 and 5 illustrate additional perspective views of the heat-staking device 100. As shown, the upright arm 104 may include a plurality of sides 400 and a channel 404 running along each side of the plurality of sides 400. In some embodiments, the head 106 includes a clamp 402 configured to couple to the channel 404 to secure the vertical position of the head 106 along the upright arm 104. The clamp 402 may comprise an L-handle, as shown in FIGS. 4 and 5. The clamp 402 may comprise any number of suitable adjustment mechanisms, and is not limited to an L-handle.

The ability to adjust the vertical position of the head 106 with respect to the base 102 may enable the heat-staking device 100 to be used for several types and/or sizes of working components. For example, with the threaded insert tray 108 shown in FIG. 1, the head 106 may need to be located relatively low on the upright arm 104 and close to the surface 406 of the base 102, as shown in FIG. 4, because the threaded insert tray 108 is relatively short. When working with a taller working component on the surface 406 of the base 102, the head 106 may need to be located higher along the upright arm 104, as shown in FIG. 5, to prevent unintentional contact between the thermal-installation tip 306 and the working component.

It is important to consider not only the location of the head 106 along the upright arm 104 but also the position of the handle 200 when the vertical height is set (i.e., by securing the clamp 402 to the channel 404 of at least one of the plurality of sides 400 of the upright arm 104). Because the handle 200 causes vertical motion of the quill 302, and, therefore, vertical motion of the thermal-installation tip 306, if the head 106 is secured too low (i.e., too close to the surface 406) with the handle 200 in the “up” position, once the handle 200 is moved to lower the quill 302, the thermal-installation tip 306 may prematurely contact the working component. FIGS. 1, 2, 5, and 6 show the head 106 in the “up” position, while FIG. 4 shows the head 106 in the “down” position. Among these, FIGS. 1, 2, and 4 show the handle 200 in the “up” position, and FIGS. 5 and 6 show the handle 200 in the “down” position with the quill 302 extended.

Though illustrated with a substantially square cross-section and a rectangular shape, it should be noted that the upright arm 104 may define any number of shapes. For example, the upright arm 104 may comprise a circular cross-section and an overall cylindrical shape. In such an embodiment, the head 106 may be shaped, sized, and arranged to receive a cylindrical upright arm 104 so that the clamp 402 is still able to secure the head 106 to the upright arm 104. Any number of suitable shapes may be possible for the upright arm 104.

FIG. 6 shows the heat-staking device 100 and includes an inset detailed view of the main head unit 300, including the handle 200 and at least one linkage bar 208. In addition, FIG. 6 illustrates a top quill stop 600a, a bottom quill stop 600b, and a threaded rod 602 extending between the top and bottom quill stops 600a, 600b. In some embodiments, the heat-staking device 100 includes at least one quill stop, such as the top and bottom quill stops 600a, 600b, coupled to the main head unit 300 adjacent to the handle 200 to restrict a vertical motion of the insulating tip holder 304 relative to the main head unit 300. In some embodiments, the quill stops 600a, 600b define the range of movement possible for the quill clamp 310, which is operated by the handle 200. A greater amount of space between the top quill stop 600a and the bottom quill stop 600b may allow the quill clamp 310 and, therefore, the quill 302 a greater range of vertical motion, while a smaller amount of space between the top and bottom quill stops 600a, 600b may reduce the range of vertical motion of the quill 302.

The top quill stop 600a may be configured to define a maximum vertical position of the quill 302 by sliding vertically on the threaded rod 602 coupled to the main head unit 300. Similarly, the bottom quill stop 600b may be configured to define a minimum vertical position of the quill 302 by sliding vertically along the threaded rod 602. Each of the top quill stop 600a and the bottom quill stop 600b may comprise educated nuts configured to move helically along the threaded rod 602. The quill stops 600a, 600b may both be positioned at a common access location for convenient adjustment by the user of the heat-staking device 100.

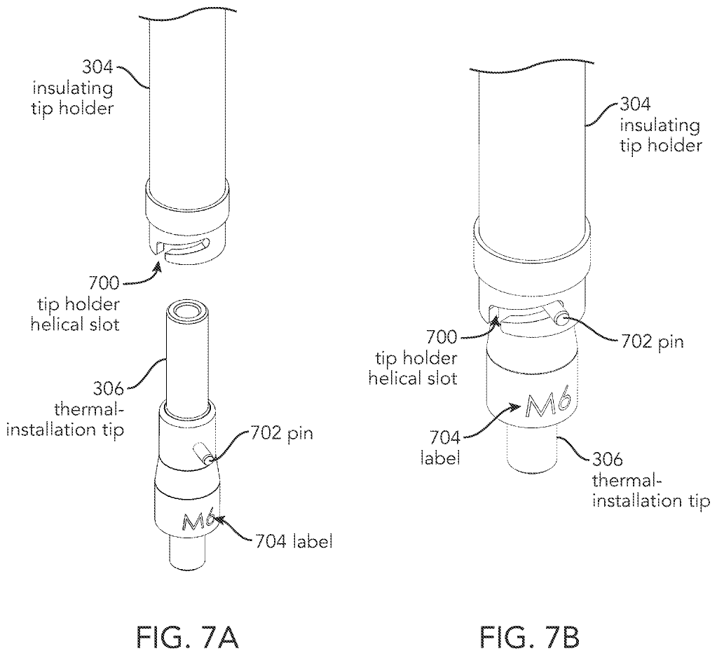

FIGS. 7A and 7B illustrate the insulating tip holder 304 and the thermal-installation tip 306 in uncoupled and coupled positions, respectively. Stated differently, FIG. 7A shows the thermal-installation tip 306 prior to (or after) retention within the insulating tip holder 304, and FIG. 7B shows the insulating tip holder 304 with the thermal-installation tip 306 retained therein. As shown in FIGS. 7A and 7B, the thermal-installation tip 306 includes a pin 702 extending radially outward from a central body of the thermal-installation tip 306. In some embodiments, the insulating tip holder 304 defines a tip holder helical slot 700 configured to receive the pin 702, as shown in FIG. 7B, to removably retain the thermal-installation tip 306 within the insulating tip holder 304. While the thermal-installation tip 306 is retained within the insulating tip holder 304, the soldering iron 308 (see FIG. 3) may be configured to heat the thermal-installation tip 306 up to a working temperature in order to heat a threaded insert (not shown).

In some embodiments, the pin 702 and the tip holder helical slot 700 enable rapid-exchange of the thermal-installation tip 306, while also resisting an undesired downward axial force that might otherwise be encountered during the installation of threaded inserts into a working component. As shown in FIGS. 7A and 7B, the thermal-installation tip 306 may include a label 704 indicating a particular size of threaded insert that the thermal-installation tip 306 is configured (e.g., sized) to install. In some embodiments, the thermal-installation tip 306 is exchangeable so that different tips of different sizes may be used with the heat-staking device 100 to enable the device 100 to install several sizes of threaded inserts.

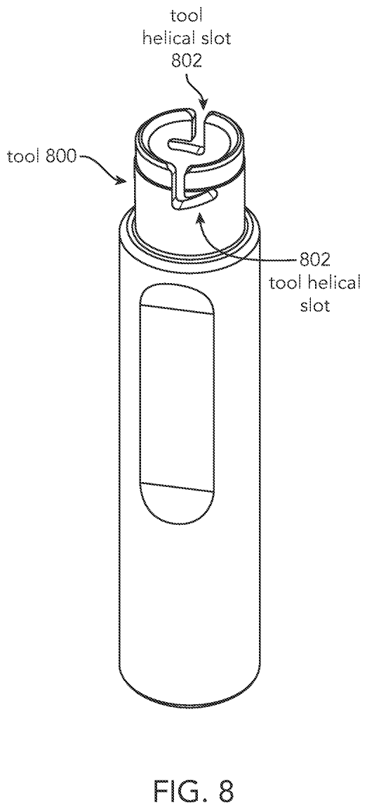

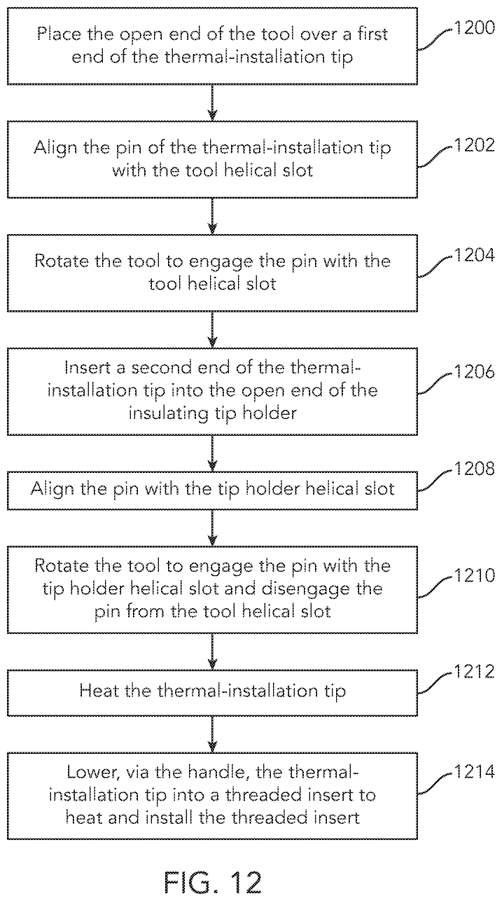

FIG. 8 illustrates a perspective view of a tool 800 including at least one tool helical slot 802. Similar to the tip holder helical slot 700, the tool helical slot 802 may be configured to receive the pin 702 of the thermal-installation tip 306 to thereby couple the tool 800 to the thermal-installation tip 306. In some embodiments, the tool 800 is configured to detachably couple the thermal-installation tip 306 to the insulating tip holder 304, as will be discussed in greater detail with reference to FIG. 12. Though pictured with two tool helical slots 802, the tool 800 may include only a single tool helical slot 802. The tool 800 may include more than two tool helical slots 802. Similarly, the insulating tip holder 304 may include one, two, or more than two tip holder helical slots 700.

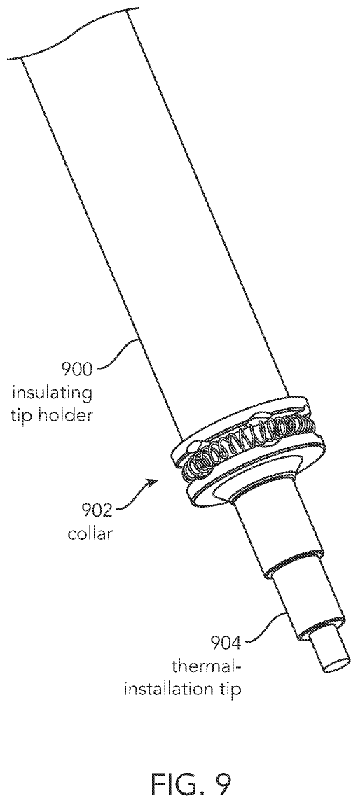

FIG. 9 illustrates an embodiment of an insulating tip holder 900 including a collar 902, wherein the insulating tip holder 900 is coupled to a thermal-installation tip 904. The thermal-installation tip 904 may be similar to the thermal-installation tip 306 previously discussed in this disclosure, though the thermal-installation tip 904 may not include the pin 702. The insulating tip holder 900 may be different from the insulating tip holder 304 in that it uses the collar 902, rather than a tip holder helical slot 700 and pin 702 to couple to the thermal-installation tip 904. In some embodiments, the collar 902 includes at least one ball (not shown) located between the spring and the thermal-installation tip 904, wherein the at least one ball is configured to hold the thermal-installation tip 904 in place with respect to the insulating tip holder 900. Though not shown, the insulating tip holder 900 may also include a release mechanism, such as a quick-release mechanism, to remove the thermal-installation tip 904.

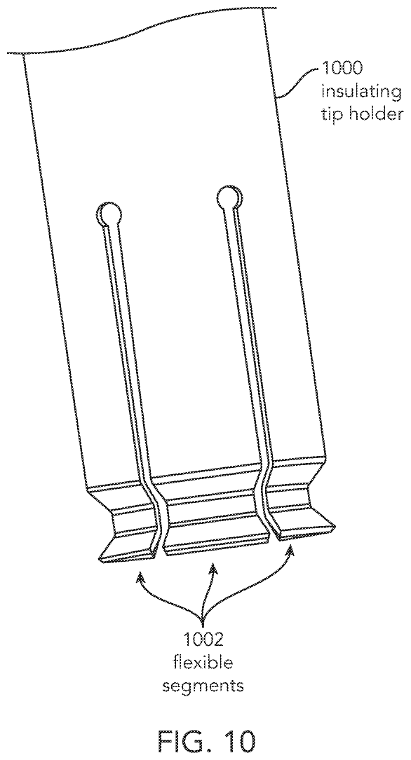

FIG. 10 shows an embodiment of an insulating tip holder 1000, which may include flexible segments 1002. In some embodiments, the flexible segments 1002 are configured to flex (e.g., bend, expand, flare out, or otherwise move) to accept a thermal-installation tip, such as the thermal-installation tip 306, the thermal-installation tip 904, or a different thermal-installation tip. Both the insulating tip holder 900 and the insulating tip holder 1000 may comprise long, thin tubes to prevent conducting heat from the soldering iron 308 into the quill 302, the head 106, or other elements of the heat-staking device 100. In addition, both the insulating tip holder 900 and the insulating tip holder 1000 may be made of materials comprising low thermal mass so that they do not easily conduct heat. It should be noted that the insulating tip holder 304 may also comprise a low thermal mass material in a long, thin tube design.

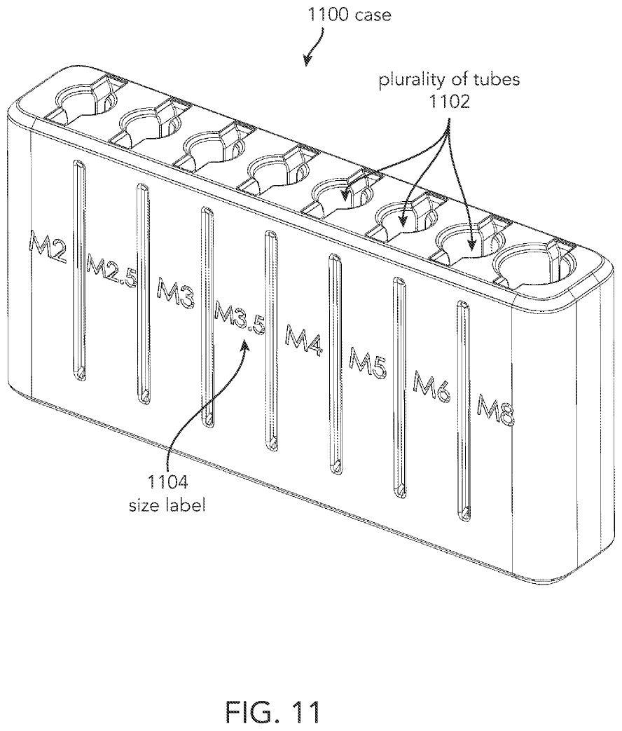

FIG. 11 shows a perspective view of an example heat-resistant case 1100 for identifying, changing, organizing, and storing thermal-installation tips, such as the thermal-installation tip 306 and/or the thermal-installation tip 904 previously discussed in this disclosure. The case 1100 may include a relatively compliant, thermally insulative material defining a plurality of tubes 1102, or compartments, to hold the thermal-installation tips. Each tube of the plurality of tubes 1102 may define a respective inner lumen and may include a size label 1104. A user may rapidly exchange thermal-installation tips, even while the tips are still hot, by placing the thermal-installation tips into the plurality of tubes 1102. While the tip is retained within each tube of the plurality of tubes 1102, the user may then squeeze the flexible material of the tube to grip the thermal-installation tip and rotate the tip such that pin 702 rotates out of the tip holder helical slot 700. Size label 1104 corresponds with label 704 of FIGS. 7A and 7B to indicate the intended size of threaded inserts (not shown) to be installed with a particular thermal-installation tip 306, 904 stored in the heat-resistant case 1100.

FIG. 12 is a flowchart showing a method of using a tool, such as the tool 800, to couple a thermal-installation tip, such as the thermal-installation tip 306, to an insulating tip holder, such as the insulating tip holder 304, and using the thermal-installation tip 306 to install a threaded insert. The method may start with placing an open end of the tool 800 over a first end of the thermal-installation tip 306, at step 1200. Next, the method may continue with aligning the pin 702 of the thermal-installation tip 306 with the tool helical slot 802, at step 1202, and rotating the tool 800 to engage the pin 702 with the tool helical slot 802, at step 1204. In some embodiments, rotating the tool 800 to engage the pin 702 comprises a one-quarter turn of the tool 800 in a first direction.

The method may continue with inserting a second end of the thermal-installation tip 306 into the open end of the insulating tip holder 304, at step 1206. In some embodiments, the second end of the thermal-installation tip 306 is located opposite the first end. The first end may be considered the “working end,” or the end of the thermal-installation tip that makes contact with a threaded insert. The method may continue by aligning the pin 702 with the tip holder helical slot 700, at step 1208. Next, the method may involve rotating the tool 800 to engage the pin 702 with the tip holder helical slot 700 and disengage the pin 702 from the tool helical slot 802, at step 1210. This rotation may again include a one-quarter turn of the tool 800, but in a second direction that is opposite the first direction (e.g., clockwise vs. counterclockwise or vice versa).

In some embodiments, the method continues by heating the thermal-installation tip 306, at step 1212. As discussed previously, the thermal-installation tip 306 may be heated by a soldering iron 308 located inside the quill 302 near the insulating tip holder 304. The method may finish by lowering, via the handle 200, the thermal-installation tip 306 into a threaded insert to heat and install the threaded insert, at step 1214. The process may be repeated in reverse to remove the thermal-installation tip 306 from the insulating tip holder 304, storing it, for example, in the case 1100, and starting the process again at step 1200 with a different-sized thermal-installation tip 306. Using the tool 800 and the case 1100 may enable a user to quickly change out thermal-installation tips 306 even while the tips are still hot because the tool 800 substantially reduces the risk of direct contact with the hot thermal-installation tip 306 and the heat-resistant case 1100 enables safe storage. The ability to quickly swap out thermal-installation tips 306 may increase the speed and efficiency of the heat-staking process.

Though not illustrated in the Figures, the heat-staking device 100 may include an integrated control system configured to operate the device 100, control the temperature of the soldering iron 308, set a timer with an automatic heat shut-off, and any number of other possible operations. The integrated control system may be a separate control unit (e.g., with a remote control) electrically and communicatively coupled to the heat-staking device, or it may comprise a control panel integrated into the housing of the device 100, such as in/on the head 106. In some embodiments, the heat-staking device 100 is configured to be compatible with a third-party control system.

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments can include A, B, and C. The term “and/or” is used to avoid unnecessary redundancy.

The term “substantially” is used to mean “completely” or “nearly completely.” For example, the disclosure includes the following: “Though illustrated with a substantially square cross-section . . . . ” In this context, a “substantially square cross-section” is used to mean a “completely” or “nearly completely” square cross-section, and does not require a 100% perfectly square cross-section.

The term “adjacent” is used to mean “next to or adjoining.” For example, the disclosure includes the following: “. . . quill stop coupled to the main head unit adjacent the handle . . . . ” In this context, “adjacent the handle” is used to mean that the quill stop is next to or adjoining the handle.

The foregoing (e.g., a control system for the heat-staking device) may be accomplished through software code running in one or more processors on a communication device in conjunction with a processor in a server running complementary software code.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

It is appreciated that in order to practice the method of the foregoing as described above, it is not necessary that the processors and/or the memories of the processing machine be physically located in the same geographical place. That is, each of the processors and the memory (or memories) used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the foregoing, be performed by a single component. Further, the processing performed by one distinct component as described above may be performed by two distinct components. In a similar manner, the memory storage performed by two distinct memory portions, as described above, may, in accordance with a further embodiment of the foregoing, be performed by a single memory portion. Further, the memory storage, performed by one distinct memory portion, as described above, may be performed by two memory portions.

Further, various technologies may be used to provide communication between the various processors and/or memories, as well as to allow the processors and/or the memories of the foregoing to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the foregoing. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software may instruct the processing machine what to do with the data being processed.

Further, it is appreciated that the instructions or set of instructions used in the implementation and operation of the foregoing may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the foregoing. Illustratively, the programming language used may include assembly language, Ada, APL, Basic, C, C++, COBOL, dBase, Forth, Fortran, Java, Modula-2, Pascal, Prolog, Python, REXX, Visual Basic, and/or JavaScript, for example. Further, it is not necessary that a single type of instruction or single programming language be utilized in conjunction with the operation of the system and method of the foregoing. Rather, any number of different programming languages may be utilized as is necessary and/or desirable.

Also, the instructions and/or data used in the practice of the foregoing may utilize any compression or encryption technique or algorithm, as may be desired. An encryption module might be used to encrypt data. Further, files or other data may be decrypted using a suitable decryption module, for example.

As described above, the foregoing may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the foregoing may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the foregoing.

Further, the memory or memories used in the processing machine that implements the foregoing may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the foregoing, a variety of “user interfaces” may be utilized to allow a user to interface with the processing machine or machines that are used to implement the foregoing. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the foregoing, it is not necessary that a human user actually interact with a user interface used by the processing machine of the foregoing. Rather, it is also contemplated that the user interface of the foregoing might interact, i.e., convey and receive information, with another processing machine, rather than a human user. Accordingly, the other processing machine might be characterized as a user. Further, it is contemplated that a user interface utilized in the system and method of the foregoing may interact partially with another processing machine or processing machines, while also interacting partially with a human user.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

We claim:

1. A heat-staking device comprising:
a base defining a surface configured to support a working component;
an upright arm coupled to the base; and
a head vertically movable along the upright arm, the head comprising:
a main head unit;
a quill coupled to the main head unit;
an insulating tip holder coupled to the quill and configured to removably retain a thermal-installation tip; and
a handle configured to rotatably move relative to the main head unit to cause a vertical motion of the insulating tip holder relative to the main head unit.

2. The heat-staking device of claim 1, wherein the quill includes a soldering iron configured to heat the thermal-installation tip.

3. The heat-staking device of claim 1, wherein the upright arm includes a plurality of sides, wherein each side of the plurality of sides includes a channel configured to receive a portion of the head to facilitate movement of the head along the upright arm.

4. The heat-staking device of claim 3, the head further comprising a clamp configured to secure the head relative to the upright arm, wherein the clamp is configured to couple to the channel in at least one side of the plurality of sides of the upright arm.

5. The heat-staking device of claim 1, further comprising a quill stop coupled to the main head unit adjacent the handle, the quill stop configured to restrict a vertical motion of the insulating tip holder relative to the main head unit.

6. The heat-staking device of claim 5, wherein the quill stop comprises an educated nut configured to move helically along a threaded rod of the main head unit.

7. The heat-staking device of claim 5, wherein the quill stop comprises a bottom quill stop, the heat-staking device further comprising a top quill stop.

8. The heat-staking device of claim 1, wherein the insulating tip holder includes a helical slot configured to receive a radial pin of the thermal-installation tip to thereby couple the thermal-installation tip to the insulating tip holder.

9. The heat-staking device of claim 1, wherein the upright arm comprises a stopper defining a minimum vertical position of the head.

10. The heat-staking device of claim 1, wherein the base comprises a plurality of legs.

11. A system comprising:
a heat-staking device including:
a base;
an upright arm coupled to the base; and
a head vertically movable along the upright arm, the head comprising:
a main head unit;
a quill coupled to the main head unit;
an insulating tip holder coupled to the quill and configured to removably retain a thermal-installation tip; and
a handle configured to rotatably move relative to the main head unit to cause a vertical motion of the insulating tip holder relative to the main head unit;
a heat-resistant case defining a plurality of receiving areas configured to receive and retain the thermal-installation tip while the thermal-installation tip is not retained within the insulating tip holder; and
a tool configured to detachably couple the thermal-installation tip to the insulating tip holder.

12. The system of claim 11, wherein the heat-resistant case comprises a compliant material.

13. The system of claim 11, wherein the thermal-installation tip comprises a first thermal-installation tip, the system further comprising a plurality of thermal-installation tips wherein each thermal-installation tip of the plurality of thermal-installation tips is sized and configured to fit a different-sized threaded insert.

14. The system of claim 13, wherein the plurality of receiving areas of the heat-resistant case is configured to receive and retain the plurality of thermal-installation tips.

15. The system of claim 11,
wherein the thermal-installation tip includes a radial pin,
wherein the tool includes a tool helical slot configured to receive the radial pin of the thermal-installation tip to thereby couple the thermal-installation tip to the tool, and
wherein the insulating tip holder includes a tip holder helical slot configured to receive the radial pin of the thermal-installation tip to thereby couple the thermal-installation tip to the insulating tip holder.

16. A method of heat staking, comprising:
detachably coupling a thermal-installation tip to a tool, wherein the thermal-installation tip includes a radial pin, and the tool includes a tool helical slot configured to receive the radial pin;
inserting, via the tool, the thermal-installation tip into an insulating tip holder of a heat-staking device, the heat-staking device further comprising:
a base;
an upright arm coupled to the base; and
a head vertically movable along the upright arm, the head comprising:
a main head unit;
a quill coupled to the main head unit;
the insulating tip holder coupled to the quill and configured to removably retain the thermal-installation tip, wherein the insulating tip holder includes a tip holder helical slot; and
a handle configured to rotatably move relative to the main head unit to cause a vertical motion of the insulating tip holder relative to the main head unit;
heating, via the quill, the thermal-installation tip; and
lowering, via the handle, the thermal-installation tip into a threaded insert to heat and install the threaded insert.

17. The method of claim 16, wherein detachably coupling the thermal-installation tip to the tool comprises:
placing an open end of the tool over a first end of the thermal-installation tip;
aligning the radial pin of the thermal-installation tip with the tool helical slot; and
rotating the tool one-quarter turn in a first direction to engage the radial pin with the tool helical slot.

18. The method of claim 17, wherein inserting the thermal-installation tip into the insulating tip holder comprises:
inserting a second end of the thermal-installation tip into an open end of the insulating tip holder, wherein the second end is located opposite the first end;
aligning the radial pin of the thermal-installation tip with a tip holder helical slot;
rotating the tool one-quarter turn in a second direction to engage the radial pin with the tip holder helical slot and disengage the radial pin from the tool helical slot, wherein the second direction is opposite the first direction; and
removing the tool.

19. The method of claim 16, further comprising:
lifting, via the handle, the thermal-installation tip from the installed threaded insert;
removing, via the tool, the thermal-installation tip from the insulating tip holder; and
inserting, via the tool, the thermal-installation tip into a case.

20. The method of claim 19, wherein the tool and the case are heat-resistant.
